(19) United States
(12) Patent Application Publication
(10) Pub. No.: US 2006/0074601 A1
(43) Pub. Date: Apr. 6, 2006

(54) Endpoint location file format, such as for use in mapping endpoints in a utility meter reading system

(75) Inventors: Steve Hoiness, Spokane, WA (US); Jeffrey N. Blum, Pullman, WA (US)

Correspondence Address: PERKINS COIE LLP;PATENT-SEA, P.O. BOX 1247, SEATTLE, WA, 98111-1247, US

(73) Assignee: Itron, Inc., Spokane, WA (US)

(21) Appl. No.: 10/957,532

(22) Filed: Oct. 1, 2004

(51) Int. Cl. G06F 11/00; G06F 15/00

(52) U.S. Cl. 702/188

(57) ABSTRACT

A method and system for locating data collection points in a mobile data collection system includes receiving geographic location information for multiple data collection points used in collecting, for example, utility consumption information. In one embodiment, the geographic location information may be in the form of an endpoint location file that a utility company may provide to an operator of a mobile data collection system for the purpose of completing a meter reading route. The geographic location information may include complete or incomplete address information and complete or incomplete geographic location coordinate information (e.g., GPS coordinates). If the geographic location coordinate information for at least one utility data collection point is incomplete, the mobile data collection system may then compute complete geographic location coordinate information.

This application is related to commonly owned U.S. application Ser. No. 10,903,886, filed Jul. 30, 2004, entitled “Mapping in Mobile Data Collection Systems, Such as for Utility Meter Reading and Related Applications,” which is incorporated herein by reference. Aspects of the invention can be modified, if necessary, to employ the systems, functions, and concepts of the various references described above to provide yet further embodiments of the invention.

### BACKGROUND

Utility companies typically rely on meter reading to determine consumption of a utility by its customers. In some utility meter reading applications, operators drive vehicles equipped with radio-equipped data collection units around an area to read electric, gas, and/or water meters. The meters are equipped with modules that allow them to send and receive signals. This style of meter reading, sometimes referred to as mobile automatic meter reading (MAMR), allows meter reading to be completed without direct access to the meter.

MAMR is sometimes used in saturated areas where there may be large populations of meters, difficult-to-access meters, or hazardous-to-read meters. When used in such areas, MAMR can dramatically improve meter reading efficiency. For example, a single data command unit transceiver reads an average of 10,000-12,000 meters in an eight-hour shift, and can read up to 24,000 meters per day, depending on meter density and system use.

Routes for MAMR are typically defined geographically and may include hundreds or thousands of meters. The meters on the route are read using one or more techniques. For example, with a wake-up technique, a MAMR vehicle moves through an area and sends wakeup signals to notify the meters in the area to send meter reading data. With a bubble-up technique, the MAMR vehicle simply picks up broadcasted signals from all meters in its vicinity. To determine the endpoints in a route, MAMR systems typically rely on route information provided by the utility. In some cases, the route information includes a list that identifies each meter using a unique meter ID and address assigned to the meter. The route information is typically formulated in advance of driving the route, and is often based on the geographic location of each meter relative to other meters in the route. For example, a MAMR route may have starting and ending points, and meters are read according to proximity from a vehicle moving between the starting and ending points.

Routes consisting of lists of meter addresses are typically provided in advance of MAMR activities, typically in the form of a route file. Such route files typically contain street address information consisting of twenty or fewer characters for each endpoint, and are configured to be used in pre-existing head-end legacy systems, such as PreimerPlus4™, MV-RS™, and Integrator™, all by Itron, Inc. of Spokane, Wash.

### BRIEF DESCRIPTION OF THE DRAWINGS

FIG. 1 is a block diagram showing an example of a system for performing mobile collection of meter reading data, including identifying out of route meters and facilitating playback of graphical route information under one embodiment.

FIG. 2 is a block diagram showing an example implementation of the mobile data collection system of FIG. 1.

FIG. 3 is a block diagram showing a data structure representation of an endpoint location file (ELF) in an embodiment of the invention.

FIG. 4 is a display diagram showing an interface associated with an endpoint location file (ELF) editor component in an embodiment of the invention.

FIG. 5A is a display diagram showing an interface associated with importing an endpoint location file (ELF) from a customer information system in an embodiment of the invention.

FIG. 5B is a display diagram showing an activity file log screen after a verification process of an endpoint location file (ELF) import has taken place in an embodiment of the invention.

FIG. 6 is a display diagram showing an interface associated with viewing information associated with an imported endpoint location file (ELF) in an embodiment of the invention.

FIGS. 7 and 8 are display diagrams showing interfaces associated with filtering endpoint location files (ELFs) using an editor component in an embodiment of the invention.

FIG. 9 is a display diagram showing an interface associated with calculating missing coordinate information for an endpoint location file (ELF) in an embodiment of the invention.

FIG. 10 is a display diagram showing an interface associated with adding missing location information to an endpoint location file (ELF) in an embodiment of the invention.

FIG. 11 is a display diagram showing an interface associated with editing an endpoint location file (ELF) using the editor component in an embodiment of the invention.

FIG. 12 is a display diagram showing mapped endpoints associated with the mapping component of the mobile data collection system of FIGS. 1 and 2.

FIG. 13 is a flow chart showing routine for importing and verifying an endpoint location file (ELF) in an embodiment of the invention.

FIG. 14 is a flow chart showing routine for editing and exporting an endpoint location file (ELF) in an embodiment of the invention.

FIG. 15 is a flow chart showing a routine for calculating missing location coordinates for an endpoint location file (ELF) in an embodiment of the invention.

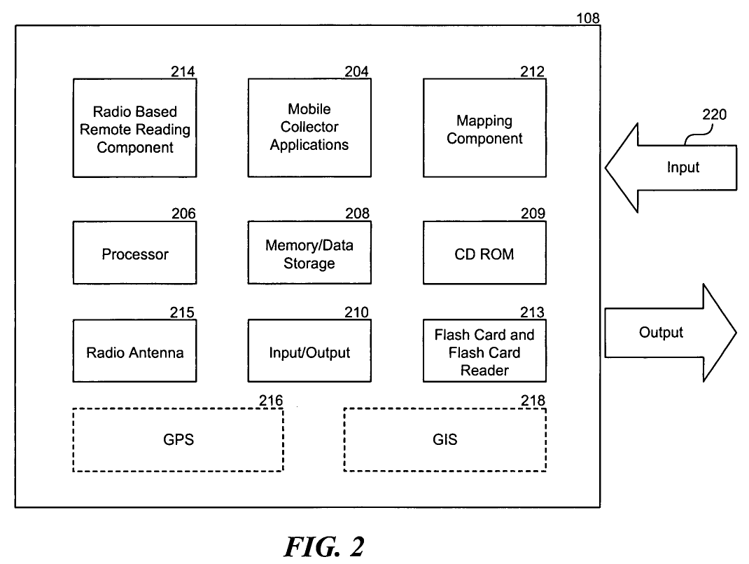

The headings provided herein are for convenience only and do not necessarily affect the scope or meaning of the claimed invention. In the drawings, the same reference numbers identify identical or substantially similar elements or acts. To facilitate the discussion of any particular element or act, the most significant digit or digits in a reference number refer to the figure number in which that element is first introduced (e.g., element 204 is first introduced and discussed with respect to FIG. 2).

A portion of this disclosure contains material to which a claim for copyright is made. The copyright owner has no objection to the facsimile reproduction by anyone of the patent document or patent disclosure (including Figures), as it appears in the Patent and Trademark Office patent file or records, but reserves all other copyright rights whatsoever.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

It is intended that the terminology used in the description presented be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

I. Overview

The method and system described herein provide an endpoint location file format that facilitates mobile automatic meter reading (MAMR) activities, such as route mapping. Some of the MAMR activities may occur at a mobile data collection system. The mobile data collection system may include a combination of components (including both hardware and software) that generally facilitate the collection of meter data from utility meters (e.g., electric, gas, water, etc.) and the graphical display of meter routes in progress via the use of maps or other features.

An endpoint location file configured in accordance with the endpoint location file format may originate in a customer information system associated with a utility provider. For example, the endpoint location file may contain location information for all endpoints recognized within the utility's customer information system. The location information allows the mobile data collection system to identify the location of each endpoint. For example, the endpoint location file may contain valid and complete address information that the mobile data collection system can use to calculate latitude/longitude for each endpoint. In addition, or alternatively, the endpoint location file may contain pre-determined location coordinates. Information from the endpoint location file may be used during operation of the mobile data collection system to facilitate the reading of meter data while traveling a route (e.g., route mapping). The information from the endpoint location file may also be used to review how a route was driven (e.g., route playback to assess efficiency of the driving route or identify issues related to the route).

In some embodiments, the endpoint location file is used in addition to one or more route files that contain information about specific routes in the meter reading system. Such route files may be created by the meter reading application and then imported and read into the mobile data collection system. When a route has been completed, the corresponding route file (containing meter reading data collected on the completed route) can be exported from the mobile data collection system back to the meter reading application and/or the utility main frame/billing system. Accordingly, in one embodiment, the endpoint location file may provide the information needed to map endpoints in a mapping interface provided by the mobile data collection system by matching the endpoint location file coordinates for endpoints to a route file.

The mobile data collection system may provide an editor component that allows the user to, for example, view, import, edit, and export endpoint location files. For example, an IMPORT function accessed through the editor component may allow the user to import a particular endpoint location file from the customer information system. In some embodiments, the editor component calculates location coordinates for a record, set of records, or the entire endpoint location file. Accordingly, an IMPORT AND CALCULATE function may allow the user to import a particular endpoint location file from the customer information system and then calculate location coordinates for all addresses that do not have them. Likewise, partially missing or incorrect address information can be determined based on provided latitude and longitude information for each endpoint (e.g., GPS coordinates generated by another system).

An UPDATE function allows the user to add to or update the information in an imported endpoint location file. For example, if the user has added additional endpoints to the meter reading system, the user might choose to update the mobile data collection system with the new information rather than importing (and thereby replacing) the entire endpoint location file.

The endpoint location file may be configured to allow the user to search for specific information contained within the endpoint location file. For example, a filtering technique may allow for a comparison of the endpoint location file to a route file that the user has imported into the mobile data collection system. For example, if the user has imported Route A into the mobile data collection system, the user may select to view the records in the endpoint location file that correspond to the records in Route A.

II. Representative System

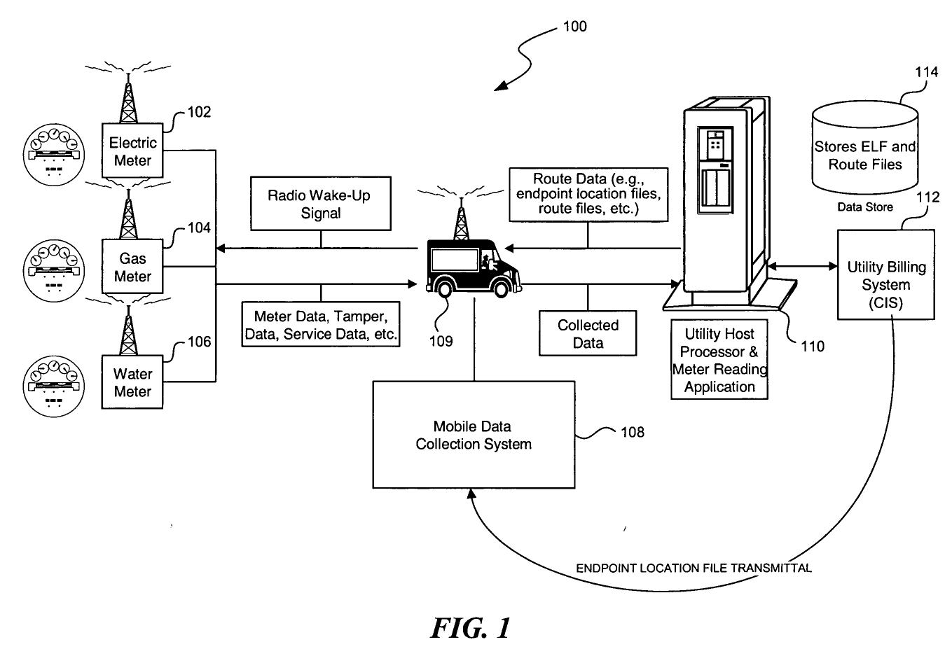

FIG. 1 and the following discussion provide a brief, general description of a suitable environment in which the invention can be implemented. Although not required, aspects of the invention are described in the general context of computer-executable instructions, such as routines executed by a general-purpose computer (e.g., a server computer, wireless device, or personal/laptop computer). Those skilled in the relevant art will appreciate that the invention can be practiced with other communications, data processing, or computer system configurations, including Internet appliances, hand-held devices (including personal digital assistants (PDAs)), wearable computers, all manner of cellular or mobile phones, embedded computers (including those coupled to vehicles), multi-processor systems, microprocessor-based or programmable consumer electronics, set-top boxes, network PCs, mini-computers, mainframe computers, and the like. Indeed, the terms “computer,” “host,” and “host computer” are generally used interchangeably and refer to any of the above devices and systems, as well as any data processor.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communication network. In a distributed computing environment, program modules may be located in both local and remote memory storage devices.

Aspects of the invention may be stored or distributed on computer-readable media, including magnetically or optically readable computer disks, as microcode on semiconductor memory, nanotechnology memory, organic or optical memory, or other portable data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme). Those skilled in the relevant art will recognize that portions of the invention reside on a server computer, while corresponding portions reside on a client computer, such as a mobile device.

Referring to FIG. 1, a MAMR system 100 on which the out of route meter read identification and graphical route playback can be implemented provides various networked components. The system 100 is an example of one arrangement of elements, but others are possible. The system 100 includes a collection of utility meters (102, 104, and 106). The utility meters may be of the same or different types (e.g., electric 102, gas 104, water 106, or other (not shown)). The utility meters (102, 104, and 106) may be distributed in a bounded or unbounded geographical area. Each utility meter (102, 104, or 106) is connected to or associated with a utility consuming facility (not shown). For example, a utility meter may correspond with a household, a commercial facility, or another utility consuming facility or device.

While not illustrated in detail, each meter (102, 104, or 106) includes a storage component (not shown) for storing collected data before transmission to a data collection system. The storage component may also store information identifying the meter, such as a meter identification number. In addition, each meter may be configured with a receiver/transmitter telemetry device (e.g., an encoder receiver transmitter (ERT)) capable of sending and receiving signals to and from a mobile data collection system 108. In general, these components (meter, storage, and telemetry device) may be collectively referred to as an “endpoint.” However, the term “endpoint” may herein refer to any one of a number of possible configurations for locally collecting data, such as utility consumption data, and not only the sample configuration described above.

In some embodiments, the mobile data collection system 108 may send a wake-up signal to an endpoint. The received wake-up signal prompts the endpoint to transmit meter reading data to the mobile data collection system 108. In alternative embodiments, “bubble-up” (broadcast) techniques may be used instead of the “wake-up” technique described above. In yet other embodiments, the mobile data collection system 108 may be capable of point-to-point communications with specific endpoints.

To facilitate MAMR or similar techniques, the mobile data collection system 108 may be installed in a vehicle 109 or be otherwise configured to be transported through a route. For example, the vehicle may include the appropriate antennas, power cables, mounts, etc.

The system 100 also includes a host processing system and meter reading application(s) 110 for processing collected meter reading data. In some embodiments, the host processing system and meter reading application 110 uses customer information to create route files used when driving the route to collect meter data. Accordingly, the host processing system and meter reading application 110 may be operating in association with systems operated by a utility company, such as a utility billing system 112 or, more generally, a customer information system (CIS). In this way, the host processing system and meter reading application 110 can also be used to communicate data to the mobile data collection system 108. This information may include both route file and endpoint location file data, which may be stored in a data store 114 prior to export from the billing system/CIS or utility host processor 110. However, in some embodiments, endpoint location files may also be transmitted directly from the billing system/CIS 112 to the mobile data collection system 108.

Data collected by the mobile data collection system 108 is returned to the meter reading application 110 for processing. Examples of meter reading applications may include MV-RS™, Premierplus4™, Viena™, and Integrator™, all by Itron, Inc. of Spokane, Wash.

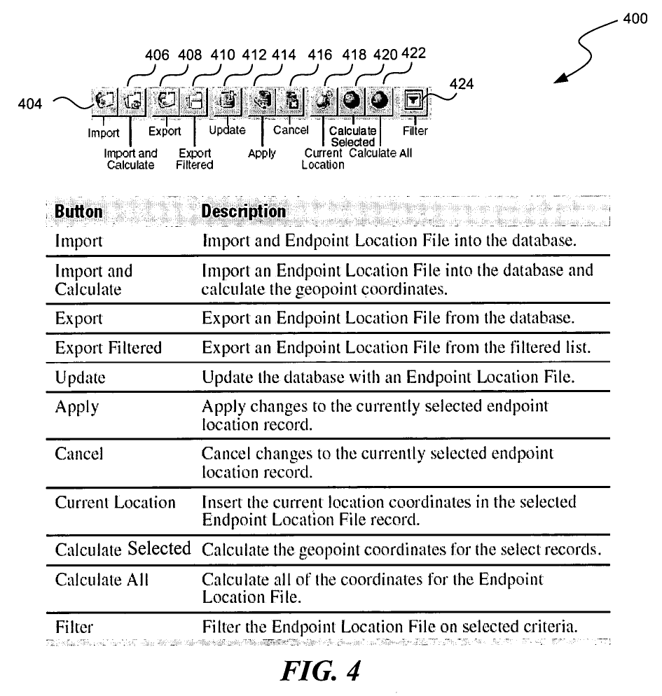

Referring to FIG. 2, the mobile data collection system 108 of FIG. 1 is shown in more detail. A mobile collector applications component 204 maintains route-related meter reading statistics, provides operating status information, and stores, processes, formats, and displays collected data. It may also include administrative functionality that administrative users can use to control preferences and settings of the data collection system. In addition, the mobile collector applications component 204 may include functionality to access and manipulate endpoint location files, such as an endpoint location file editor component, which is described in more detail with respect to FIGS. 4-11.

A processor 206 and memory or other data storage 208 provide capabilities to control several processes, including management of collected meter reading data and processing of input for purposes of determining an efficient route for meter reading. For example, the memory 208 can store not only collected meter data, but also route and other information. A CD ROM 209 may handle removable media in the mobile data collection system 108. A user input/output component 210 provides an appropriate user interface for an operator of the data collection system 108. For example, the mobile data collection system 108 may provide a color touch screen display for ease of use and clear graphical mapping displays. Other user input/output options may be used including mouses, microphones, speakers, joysticks, keyboards, LCD screens, audio, etc.

One application of the input/output component 210 includes displaying and controlling mapping images generated by a mapping component 212. In this way, the operator is provided with feedback, so that he or she can determine which meter readings have been completed on a particular route and so he or she can view meters on the route in relation to the vehicle and to other meters. The mapping component 212 (e.g., Microsoft MapPoint) may interface with the mobile collector applications component 204.

Any one of the components described above may be contained on a notebook computer or other device that can be easily removed from the vehicle when not in use, such as the Itronix™ GoBook MAX™.

In some embodiments, route data may be transferred to and from the mobile data collection system 108 using a removable flash card 213. For example, an operating system (not shown) associated with the mobile data collection system 108 may recognize the flash card 213 as a removable drive, allowing standard file access. In other embodiments, the routes may be transferred to the mobile data collection system via a local area network (LAN), a wide area network (WAN), etc. Periodic data backups to the flash card can be configured in the mobile collector applications component 204.

The mobile data collection system 108 also includes a radio based remote reading component 214, which, in some embodiments, may include a transceiver. The radio based remote reading component 114 may, via a radio antenna 215, send signals to wake-up meters that function in “wake-up” mode and to receive and manage incoming data. In addition to or as an alternative to the mapping component 212, the mobile data collection system 108 may also include a Global Positioning System (GPS) component 216, a Global Information Services (GIS) component 218, or like systems (e.g., systems that facilitate location determination via cellular telephone network), which may be used to facilitate mapping and other related functionality, such as route playback features.

In general, GPS uses a network of satellites that continuously transmit coded information that makes it possible to precisely triangulate locations on earth by measuring the distance from satellites. GPS signals broadcast line of sight, meaning that the signals will pass through clouds, glass, and plastic but will not pass through most solid objects, including people, buildings, and mountains. The GPS receiver provides increased accuracy of positioning data as the number of accessible satellites increases. Accordingly, aspects of the mapping component can be configured to inform the operator of the number of satellites available.

Where the GPS component 216 is implemented, operators of the mobile data collection system 108 can use latitude and longitude coordinates to locate endpoints in the field and to track the progress of the mobile collection vehicle while driving the route. In some embodiments, the GPS component 216 uses embedded mapping software to map the GPS coordinates in any given area (including geography, roads, landmarks, etc.). In some embodiments, an endpoint location file (shown as input 220) provided to the mobile data collection system 108 provides information on endpoint locations.

III. Data Structure and Format of Endpoint Location File

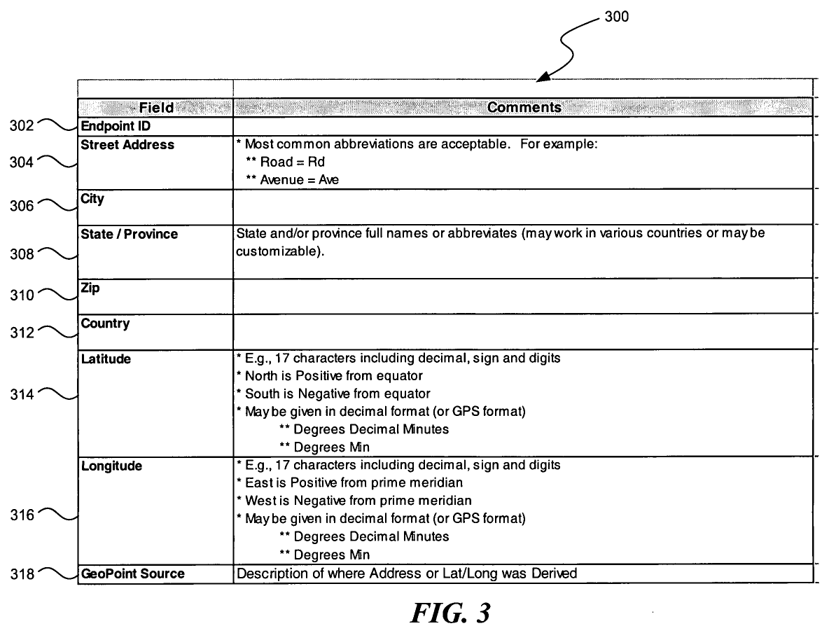

Referring to FIG. 3, the data structures of the endpoint location file may vary, but in general, such data structures correspond to information needed to determine a location for each endpoint in the meter reading system. For example, each endpoint in the file may correspond to a record data structure in the endpoint location file. Examples of information used for each record in the endpoint location file include an endpoint ID 302, a street address 304, a city 306, a zip code 308, a country 310, a latitude 312, a longitude 314, and a geopoint source 316 that describes the source of the address or coordinate information for each endpoint. In some embodiments, new fields may be added or existing fields may be modified to capture information, such as address information in other countries (e.g., state/province names in Mexico or Canada). In addition, the data structures used may allow the utility to assign codes or other features to components of the system. For example, the data structures may allow a utility to assign a code to a record or field that translates into a particular symbol being displayed on the map.

In some embodiments, the endpoint location file is a comma delimited file, such as a comma separated variables (.CSV) text file. However, almost any type of file format can be used without departing from the scope of the invention. With a comma delimited file, a comma placeholder separates each field in the endpoint location file layout. Blank spaces between commas may be allowed as the mobile data collection system may be configured to calculate such missing information based on the provided information. In some embodiments, a verification process invoked during import of the endpoint location file to the mobile data collection system removes blank spaces at the beginning and end of fields, trims leading zeroes from endpoint ID numbers, and/or performs other data formatting.

IV. User Interface

Various user screens, views, and other interfaces may allow users to monitor and manage meter reading route activities using information from endpoint location files. Examples of such screens are described with respect to FIGS. 4-11. While only certain examples are given, a person skilled in the art will appreciate that many other interfaces could be implemented without departing from the scope of the invention. The terms “view,” “screen,” “window,” and “page” are generally used interchangeably herein. The pages described herein may be implemented using, for example, WML (wireless markup language), XHTML (extensible hypertext markup language), XML (extensible markup language), or HTML (hypertext markup language). In some embodiments, WML and XHTML decks offer similar functionality but may differ with respect to style guide and design requirements between the two languages (use of color, icons, etc.).

In some cases, the screens or pages provide facilities to receive input data, such as a form with fields to be filled in, pull-down menus or entries allowing one or more of several options to be selected, buttons, sliders, hypertext links, or other known user interface tools for receiving user input. While certain ways of displaying information to users are shown and described with respect to certain Figures, those skilled in the relevant art will recognize that various other alternatives may be employed.

The pages or screens are stored and/or transmitted as display descriptions, as graphical user interfaces, or by other methods of depicting information on a screen (whether personal computer, PDA, mobile telephone, or other) where the layout and information or content to be displayed on the page are stored in memory, database, or other storage facility.

When implemented as web pages or wireless content, the screens are stored as display descriptions, graphical user interfaces, or other methods of depicting information on a computer screen (e.g., commands, links, fonts, colors, layout, sizes and relative positions, and the like), where the layout and information or content to be displayed on the page are stored in a database. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the invention are described herein using a networked environment, some or all features may be implemented within a single-computer environment.

In general, for ease in describing features of the invention, aspects of the invention will now be described in terms of a user (e.g., a mobile data collection system operator) interacting with the mobile data collection system. However, one skilled in the art will recognize that the various functions and operations described below are facilitated by various routines and components within the system.

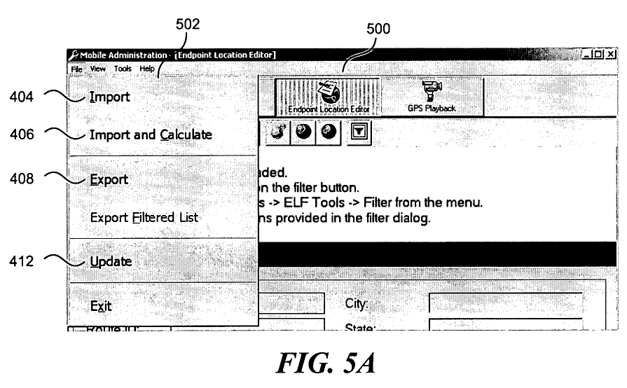

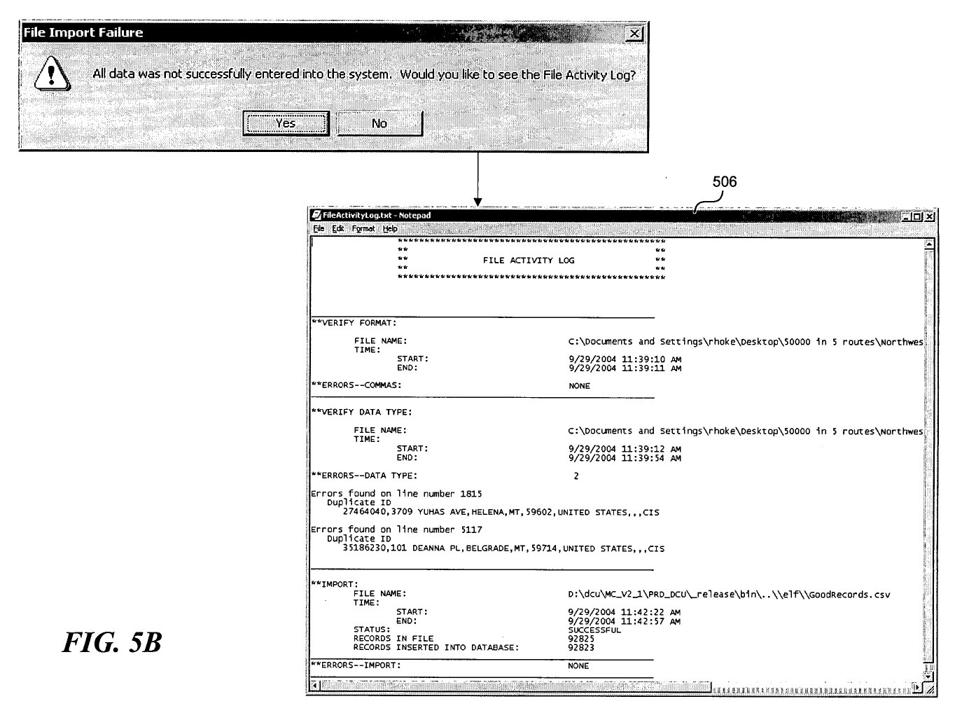

Referring to FIGS. 4 and 5, the mobile data collection system may provide an editor component 500 that allows the user to, for example, view, import, edit, and export endpoint location files. In some embodiments, the editor component can insert coordinates for a record, set of records, or the entire endpoint location file.

The editor component may include a toolbar 402 by which the user may request to perform several functions on the endpoint location form. In the illustrated example, such functions include an IMPORT function 404, an IMPORT AND CALCULATE function 406, an EXPORT function 408, an EXPORT FILTERED function 410, an UPDATE function 412, an APPLY function 414, a CANCEL function 416, a CURRENT LOCATION function 418, a CALCULATE SELECTED function 420, a CALCULATE ALL function 422, and a FILTER function 424. Various aspects of such functions are described with respect to FIGS. 5-15, and the accompanying text.

A. Importing an EndPoint Location File and Related Functionality

Once an endpoint location file is created, a user can import it from a customer information system or other location into an application associated with the mobile data collection system. In the illustrated embodiment, importing can be associated with additional functionality such as calculating location coordinates and updating the endpoint location file. In some embodiments, file activities, including imports, updates, and calculations, create a file activity log. In the event of a failed process, the application of the mobile data collection system may prompt the user to view the log.

Referring to FIG. 5, in some embodiments, to import an endpoint location file, the user selects the IMPORT function 404 from the editor component toolbar 402 or from a file menu 502. The user may then browse for the desired endpoint location file (not shown). After selection of the desired endpoint location file, the user selects an OPEN button (not shown). As a result, a VERIFY FILE DATA dialog box appears 504.

This dialog box provides 504 the user with the option to verify the imported file to check for format and/or data type errors, and thereby prevent associated problems, such as halting the entire import. A failed verification may be analyzed via a file activity log 506 that corresponds to the endpoint location file, as shown in FIG. 5B.

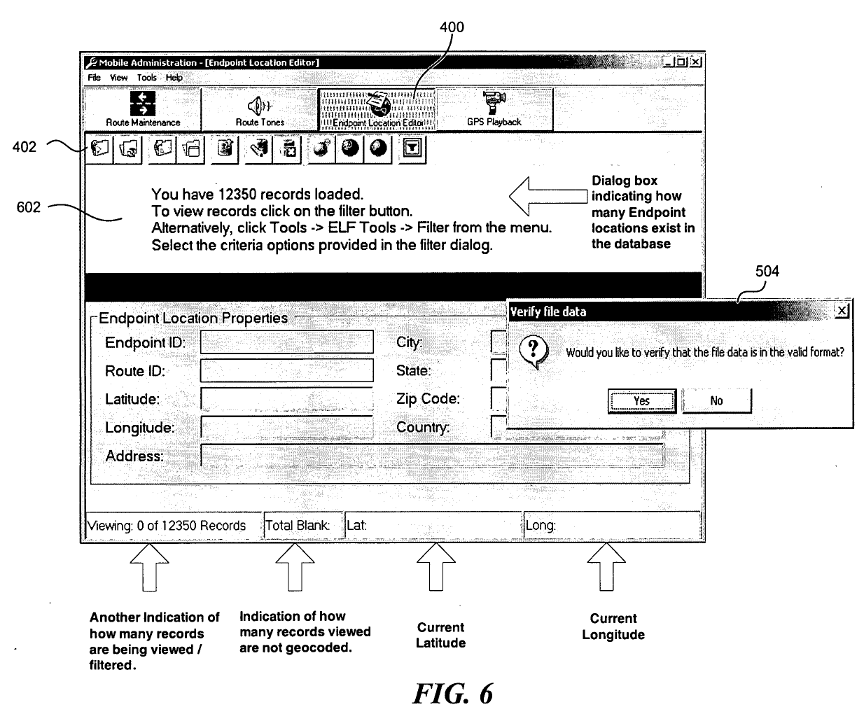

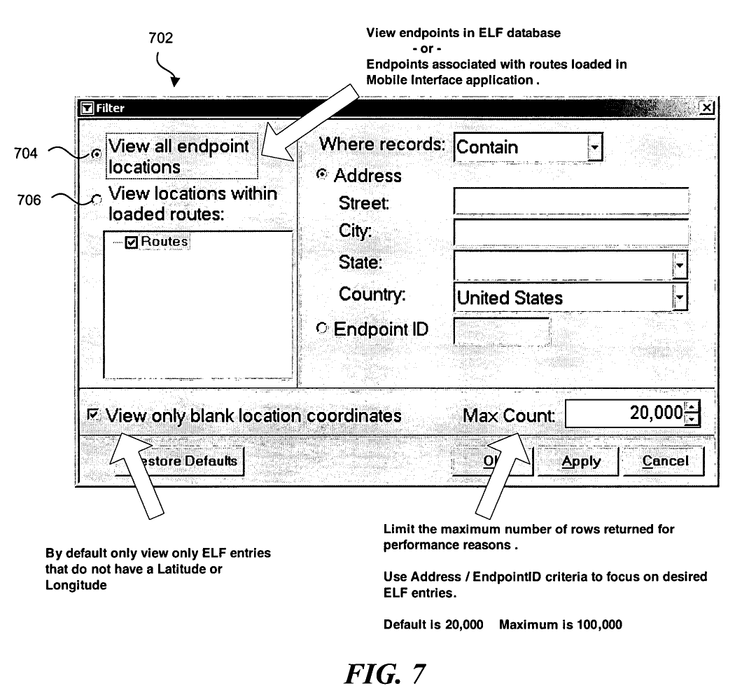

Referring to FIG. 6, when the import is complete, a message appears 602 indicating the number of records imported, with each record corresponding to an endpoint. To view the individual records, the user may use filtering techniques, which are described in more detail with respect to FIGS. 7-11.

In some embodiments, when the user selects to import an endpoint location file, any previously existing endpoint location data used by the application (e.g., in a previous session) is replaced with information from the newly imported endpoint location file.

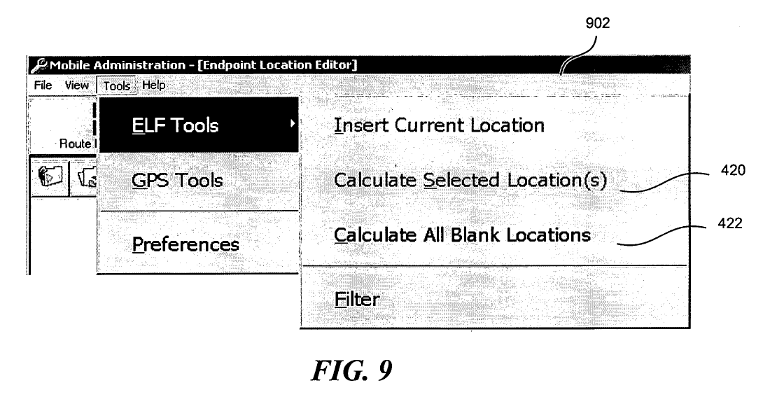

Referring again to FIGS. 4 and 5, if the user selects the IMPORT AND CALCULATE function 406 from the editor component toolbar 402 (or file menu 502), the system imports the endpoint location data and calculates coordinates for any endpoints that lack coordinate information. This calculation may be based on the address information of the endpoint and is described in more detail below in the text corresponding to FIG. 9. In some embodiments, the mobile data collection system is also able to populate missing information, such as a missing part of an endpoint address. The remaining steps associated with the IMPORT AND CALCULATE function 406 are similar to those outlined above with respect to the IMPORT function 404.

B. Filtering an Endpoint Location File

Because a utility provider may create a single endpoint location file that contains data for all of its endpoints, an imported endpoint location file may be quite large. Accordingly, the mobile data collection system may provide the FILTER function 424 that allows a user to work with only a portion of the endpoint data (e.g., only endpoint information for a particular route).

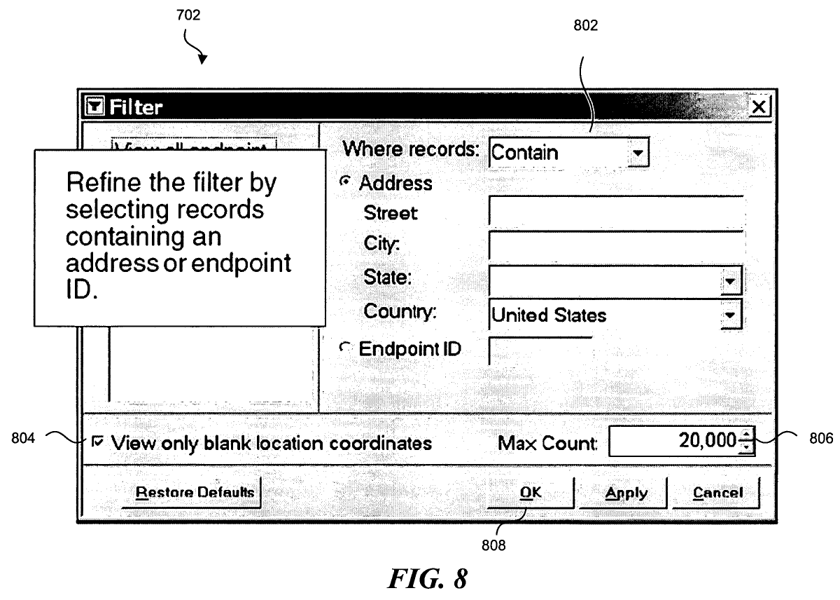

Referring to FIGS. 7 and 8, in some embodiments, to filter an imported endpoint location file, the user begins by selecting the FILTER function 424 from the editor component toolbar 402. This results in the display of a SET FILTER dialog box 702, from which the user may select the source of the data the user wishes to filter. For example, to view all of the data in the import endpoint location file, the user may select a VIEW ALL ENDPOINT LOCATIONS option 704. Alternatively, to view only the data related to a particular route, the user may select a VIEW LOCATIONS WITHIN LOADED ROUTES option 706 and select the route(s) the user wish to use. In some embodiments, the editor component 400 also allows the user to expand the loaded routes and select only specific segments within those routes. Each loaded route corresponds to a route file that has been loaded into the mobile data collection system.

Referring to FIG. 8, in some embodiments, the user may perform a more refined search by providing filter criteria for use with the FILTER function 424. Examples of filter criteria include: a CONTAINS criteria 802 (e.g., to search for all endpoints on Boone Street, the user might filter by addresses containing the word “Boone”); an EQUALS criteria (e.g., to search for an exact address 1234 Boone); a STARTS WITH criteria (e.g., to search for endpoints that start with “2”); an ENDS WITH criteria (e.g., to search for endpoints that end with “4”); etc. The user may also apply selected criteria to specific fields of the record (e.g., address, endpoint number, longitude, etc.). In some embodiments, other filter criteria may exist. For example, the user may apply the filter to view all records with blank location coordinates 804. In addition, the user may be able to select a maximum number of records to return 806 in the filter (e.g., 9 or 99,000).

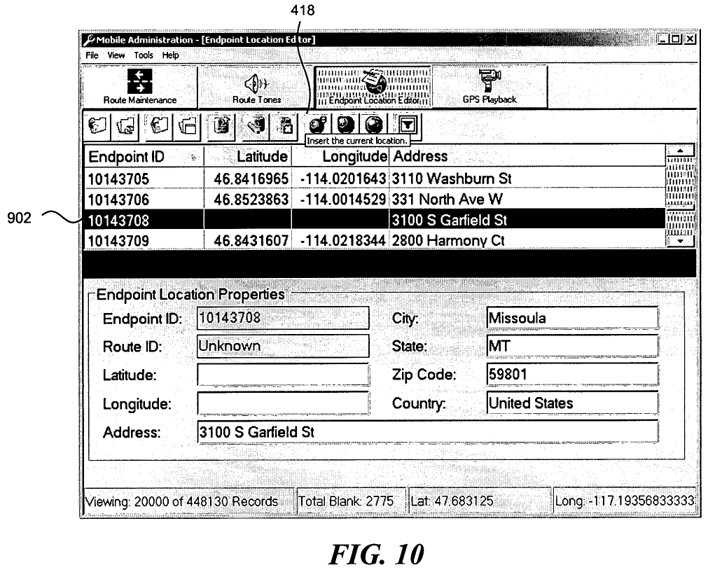

After the user inputs the filter criteria and selects an OK button 808, the mobile data collection system displays the filter results (see e.g., FIG. 10). A status bar at the bottom of the screen may show the number of records contained in the filtered data set, the number of records that do not have latitude/longitude information, the current latitude and longitude if the user is operating the mobile data collection system in the field, etc.

C. Calculating Location in an Endpoint Location File

Not all endpoint location files have complete location information (e.g., lat/long coordinates) for each record (e.g., endpoint). However, the mobile data collection system can still rely on such “blank” records provided that coordinate information can be calculated using address information (e.g., valid street address and a valid city or zip code) associated with such records. A similar operation may be performed to update incomplete or incorrect address information based on provided or calculated coordinate information (e.g., the mobile data collection system may update the city, state, zip, and/or country fields with correct data based on the given coordinates). For example, after the mobile data collection system calculates coordinates for a record with missing country information, the mobile data collection system may fill in the missing country information. Similarly, if the country was misspelled “Untd Staets,” the endpoint location file editor would correct it to “United States.”

In some embodiments, to calculate the current location (latitude and longitude) for a record or group of records the user highlights selected records and selects the CALCULATE SELECTED function 420 from the editor component toolbar 402 or a tools menu 902, as shown in FIG. 9. To calculate the current location for all endpoint records in the endpoint location file that do not have coordinates, the user selects the CALCULATE ALL function 422 from the editor component toolbar or the tools menu 902. The calculated endpoints are then displayed in a dialog box.

Referring to FIG. 10, another option for populating an endpoint location file with missing location coordinates is by allowing the user to insert location information while physically at the location/address of the endpoint (e.g., using equipment with location sensing capabilities such as the Itronix™ GoBook MAX™). To insert the coordinates of the current location into a record in this way, the user attaches the location sensing equipment or a similar device to the mobile data collection system and drives to the endpoint location. The user uses the editor component 400 of the mobile data collection system to filter the endpoint location file to access the appropriate records for the route. Alternatively, the user may use a filter to access a record for a specific address. The user then selects the desired record 902 and selects the CURRENT LOCATION function 418 from the editor component toolbar 402. In response, the mobile data collection system enters the latitude and longitude of the current location into the record, based on information provided by the location sensing equipment.

D. Updating and Editing an Endpoint Location File

There may be more than one way to modify the contents of an imported endpoint location file. In some embodiments, it may be possible to add or delete complete records using the UPDATE function 412. For example, if the user has added additional endpoints to the meter reading system, the user might choose to update the mobile data collection system with the new information rather than having to report the information and then import a new endpoint location file. In some embodiments, updating an endpoint location file adds and/or overwrites records in the endpoint location file that has been imported to the mobile data collection system.

To add to or update information in an endpoint location file that the user has already imported into the mobile data collection system, the user may select the UPDATE function 412 from the editor component toolbar 402. The user then browses and selects the desired endpoint location file. When the update is complete, a message may appear indicating the number of records that have been updated, which can be viewed via filtering. In some embodiments, if the user selects another record before clicking update, an update confirmation dialog appears.

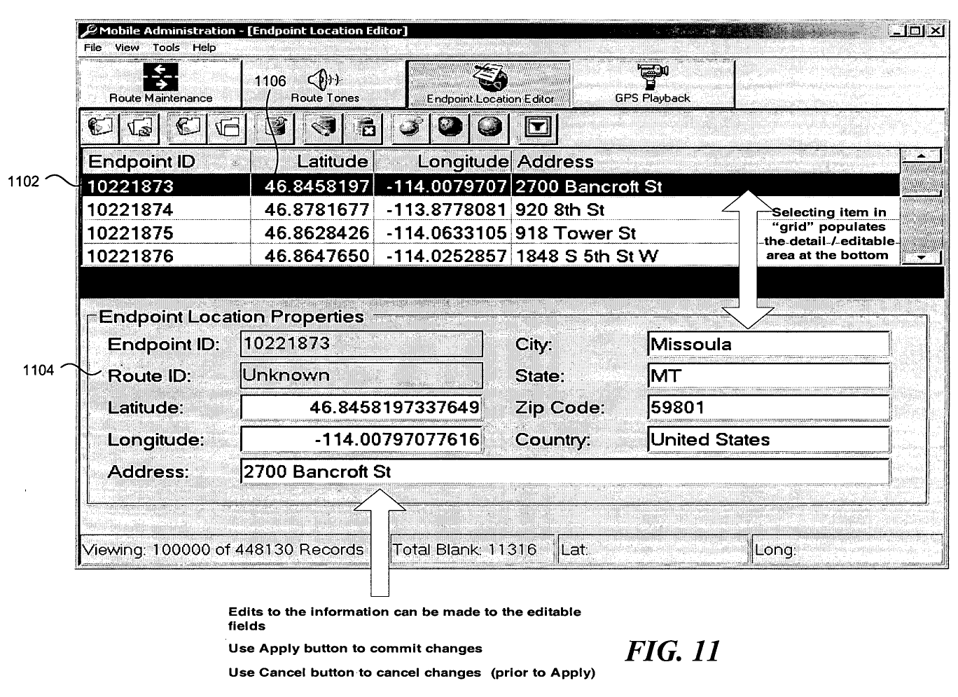

In addition to writing over or creating new records via the update feature, it may also be possible to edit existing records (e.g., add or correct missing or inaccurate information within a record) by using an editing feature accessed via the editor component 400. Referring to FIG. 11, the user begins the editing process by highlighting the row of the selected record 1102. As a result, the editor component 400 displays details for the record in a display area 1104. From this display area 1104, the user can edit the record's information as needed. The user clicks an APPLY button (not shown) to save the changes and then clicks an OK button (not shown) to save the changes to the record and continue updating.

In some embodiments, to make editing easier, the user can sort the data in the endpoint location file by clicking on a column head. For example, to sort by latitude, the user clicks on a latitude column heading 1106.

E. Exporting an Endpoint Location File

Once an endpoint location file has been imported and edited or updated, the mobile data collection system may enable the export of the endpoint location file back to the customer information system or to a backup location, or other location by using the EXPORT function 408 or EXPORT FILTERED function 410, which can be accessed from the editor component toolbar 402, as shown in FIG. 4. In some embodiments, the EXPORT function 408 allows the user to name the desired endpoint location file, select the desired export location, and click OK to complete the export. The EXPORT FILTERED function 410 allows the user to select to export only a subset of the endpoint location file (e.g., a filter set of records).

In general, the various depicted features and functions (e.g., import, update, calculate, export, etc.) can be applied to other features of the system in addition to the endpoint location files. For example, such features and functions may be applied in the context of route files, meter servicing files, or any other information used in the mobile data collection system.

F. Route Mapping Example

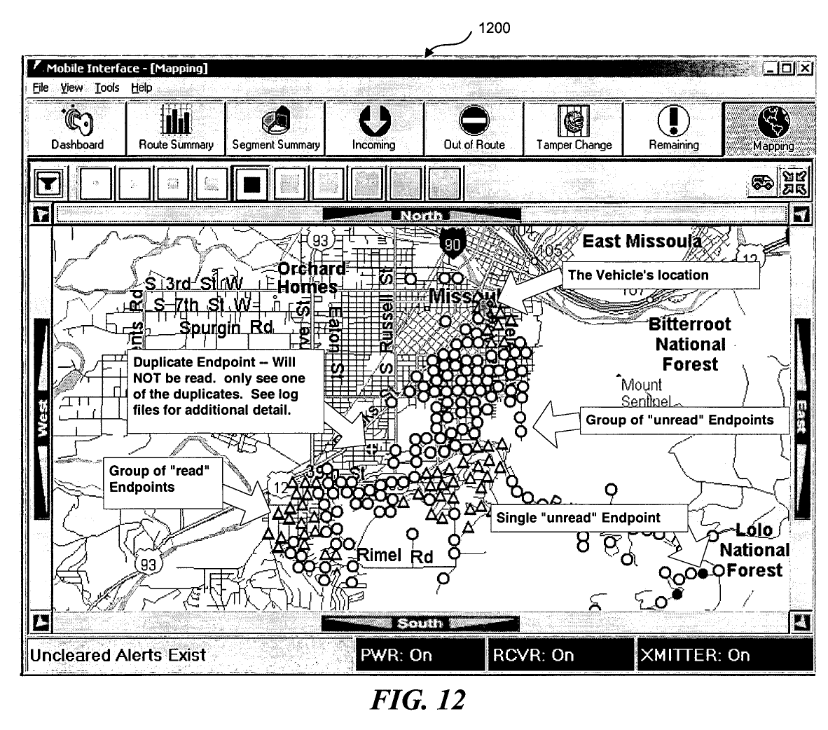

While information in the endpoint location file may be used for any number of purposes during meter reading route management, one application involves the use of route mapping, an example of which is provided with respect to FIG. 12.

Referring to FIG. 12, a user may monitor route reading progress using a mapping view 1200. The mapping view 1200 allows the user to see the vehicle's location and the changing status (e.g., unread, read, out of route, etc.) of route endpoints as travel over a route progresses. Many different types of endpoints may be shown, including single read endpoints, single unread endpoints, single groups of read endpoints, single groups of unread endpoints, and the vehicle. It may also be possible for the user to choose special or custom map symbols associated with their specific criteria. In the illustrated embodiment, the map is dynamic, meaning that it changes as the meter reading route progresses. For example, unread endpoints may change to read endpoints as readings occur, and new endpoints may appear on the map as they come into range. In addition, the mapping may provide information about the order or timing of a communication with an endpoint. For example, the most recent endpoints (e.g., most recently read) may appear in a bright resolution while the older endpoints (e.g., least recently read) may appear slightly faded.

In some embodiments, the map may be interactive by allowing users to drill down on specific endpoints. For example, clicking on or touching an endpoint on the map may result in the display of specific information regarding the endpoint.

V. System Flows

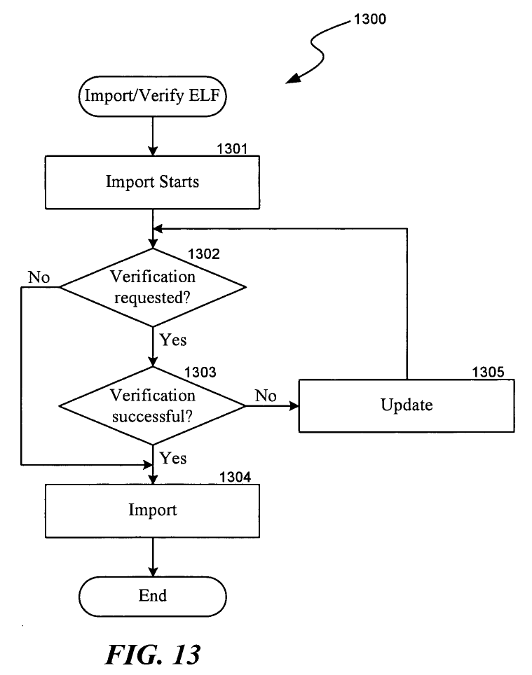

FIGS. 13-16 are representative flow diagrams that show processes and the flow of information that occur within the system of FIG. 1. These flow diagrams do not show all functions or exchanges of data but, instead, provide an understanding of commands and data exchanged under the system. Those skilled in the relevant art will recognize that some functions or exchanges of commands and data may be repeated, varied, omitted, or supplemented, and other aspects not shown may be readily implemented. For example, while not described in detail, a message containing data may be transmitted through a message queue, over HTTP, etc.

Referring to FIG. 13, a routine 1300 for importing/verifying an endpoint location file at a mobile data collection system is shown. At block 1301, the import routine 1300 begins with the mobile data collection system establishing communication with the utility customer information system or meter reading application. More specifically, the user may locate and select a file that was created by either the CIS or the meter reading applications. At decision block 1302, if the user does not request verification of the endpoint location file, the routine 1300 continues at block 1304. Otherwise, the routine 1300 skips to block 1304 to complete the import of the unverified endpoint location file. If, however, at decision block 1302, the user request verification of the endpoint location file, the routine 1300 continues at decision block 1303. If at decision block 1303, the verification is successful, the routine 1300 continues at block 1304 to import the verified endpoint location file. If, however, at decision block 1303, the verification is not successful, the endpoint location file can be updated (by the user or possibly automatically) before looping back to decision block 1302, where a second verification can be requested.

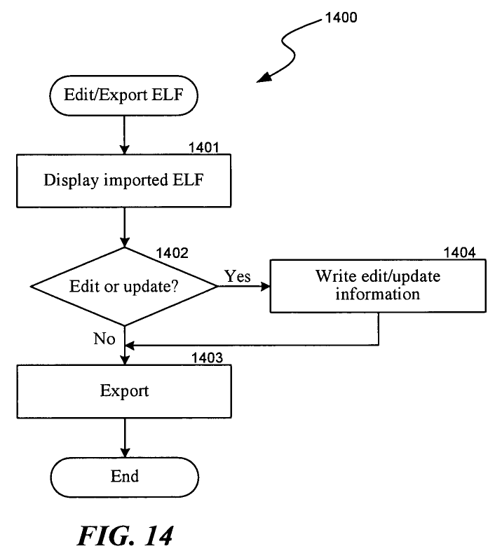

Referring to FIG. 14, a routine 1400 for editing/exporting an endpoint location file is shown. At block 1401, the routine 1400 displays information relating to an imported endpoint location file. The displayed information may be filtered information relating to specific records in the endpoint location file or may be related to all the records in the endpoint location file. At block decision block 1402, if the user does not request to edit or update the endpoint location file, the routine 1400 continues at block 1403, where the routine exports the endpoint location file to the customer information system or the host processor/meter reading application. If, however, at decision block 1402, the user requests to edit or update the endpoint location file, the routine 1400 continues at block 1404, where the routine writes the updated or edited information to the endpoint location file. The routine 1400 then continues at block 1403, where the routine exports the updated/revised endpoint location file to the customer information system or the host processor/meter reading application. The routine 1400 then ends.

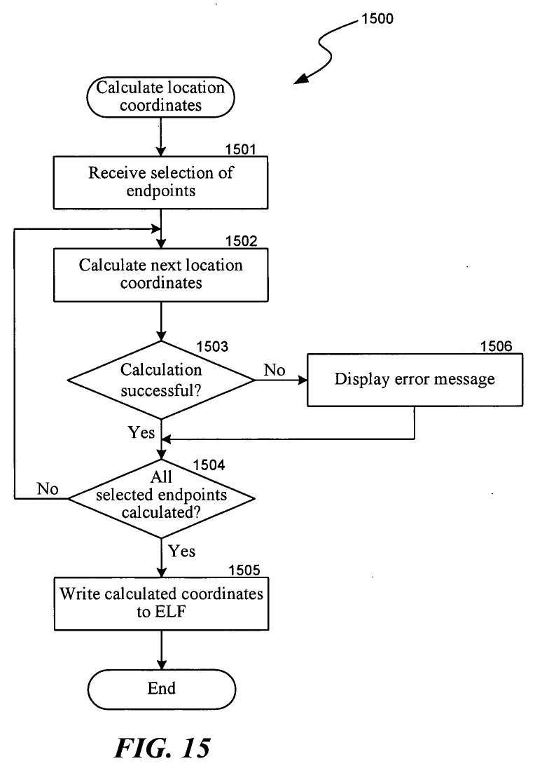

Referring to FIG. 15, a routine 1500 for calculating location missing or incomplete location coordinates for endpoints in an endpoint location file is shown. At block 1501, the routine 1500 receives a selection of endpoints for which endpoints need to be calculated (e.g., the user can select to calculate coordinates for all endpoints with missing location coordinates or for a selected set of endpoints). At block 1502, the routine 1500 calculates the endpoint coordinates for the first endpoint in the selection. At decision block 1503, if the calculation is successful, the routine 1500 continues at decision block 1504, where the routine checks if the coordinates for all endpoints in the selection have been calculated. Otherwise, if at decision block 1503, the calculation is not successful, the routine 1500 displays an error message at block 1506 before continuing on to decision block 1504. At decision block 1504, if coordinates for all selected endpoints have been calculated, the routine 1500 proceeds to block 1505, where the routine writes the calculated coordinates to the endpoint location file before ending. If, however, at decision block 1504, all coordinates for the selected endpoints have not been calculated, the routine 1500 loops back block 1502 to calculate the location coordinates for the next selected endpoint.

While the above routine 1500 relates to calculating location coordinates for endpoints, other types of determinations related to the endpoint location file may be made in a similar way without departing from the scope of the invention. For example, a similar routine may be invoked to determine missing or incorrect address information. In another example, business rules may be applied to determine or assign specific mapping symbols to use (e.g., if endpoint A matches XYZ criteria, the use a pink star when displaying it on a map).

### VI. CONCLUSION

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number, respectively.

The teachings of the invention provided herein can be applied to other systems, not necessarily the system described herein. The elements and acts of the various embodiments described above can be combined to provide further embodiments.

These and other changes can be made to the invention in light of the above Detailed Description. While the above description details certain embodiments of the invention and describes the best mode contemplated, no matter how detailed the above appears in text, the invention can be practiced in many ways. Details of the mobile data collection system may vary considerably in their implementation details, while still be encompassed by the invention disclosed herein. As noted above, particular terminology used when describing certain features or aspects of the invention should not be taken to imply that the terminology is being re-defined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A computer-readable medium comprising a data structure including utility endpoint location information for use with a mobile utility data collection system, the data structure comprising:
information associated with identifying the utility endpoint, wherein the utility endpoint corresponds to an intermediate collection point for meter data associated with the consumption of a utility;
at least one of
address information associated with the location of the utility endpoint, wherein the address information includes one or more of a street address, a city, a state or province, a zip code, and a country, and wherein the address information is determined by the mobile utility data collection system if not accurately provided, and
geographic location coordinate information associated with the location of the utility endpoint, wherein the location coordinate information is calculated by the mobile utility data collection system if not initially provided; and
wherein the data structure is included as a record in a utility endpoint location file containing information from multiple utility endpoints recognized in the mobile utility data collection system, and wherein the utility endpoint location file is used in providing a graphical display of at least some of the multiple utility endpoints during or after performing a mobile automatic meter reading route using the mobile utility data collection system.

2. The computer-readable medium of claim 1 wherein the utility endpoint location file is used to display a map of a mobile automatic meter reading route being performed using the mobile utility data collection system.

3. The computer-readable medium of claim 1 wherein the data structure further comprises information describing a source of the address information, if provided and/or the source of location coordinate information, if provided.

4. The computer-readable medium of claim 1 wherein the computer-readable medium is a memory of the mobile data collection system.

5. The computer-readable medium of claim 1 wherein the computer-readable medium is a logical node in a computer network receiving the contents.

6. The computer-readable medium of claim 1 wherein the computer-readable medium is a computer-readable disk.

7. The computer-readable medium of claim 1 wherein the computer-readable medium is a data transmission medium carrying a generated data signal containing the contents.

8. The computer-readable medium of claim 1 wherein the computer-readable medium is a memory of a computer system.

9. The computer-readable medium of claim 1 wherein the utility endpoint location file is a comma delimited file.

10. A method for locating data collection points in a mobile utility data collection system, the method comprising:
receiving, in a computer-readable medium, location information for multiple utility data collection points used in collecting utility consumption information, wherein the location information for the multiple utility data collection points includes complete or incomplete address information and complete or incomplete geographic location coordinate information; and
if the geographic location coordinate information for at least one utility data collection point is incomplete, determining complete geographic location coordinate information for the at least one data collection point.

11. The method of claim 10 wherein the complete geographic location coordinate information is determined by driving the mobile utility data collection system to the geographic location, automatically collecting geographic location coordinate information, and inputting the collected geographic location coordinate information.

12. The method of claim 10 wherein determining the complete geographic location coordinate information is based on the complete or incomplete address information.

13. The method of claim 10, further comprising, if the address information is incomplete for another one of the utility data collection points, determining complete address information for the another one of the utility data collection points.

14. The method of claim 10, further comprising, if the address information is incomplete for the at least one utility data collection points, determining additional address information for the at least one data collection point, wherein the determining the additional address information is based on the complete or incomplete geographic location coordinate information.

15. The method of claim 10, further comprising using the complete geographic location coordinate information for displaying at least some of the multiple data collection points on a map display during performance of a mobile automatic meter reading route.

16. The method of claim 10, further comprising using the complete geographic location coordinate for displaying at least some of the multiple data collection points on a map display after the performance of an automatic meter reading route.

17. The method of claim 10, further comprising, validating the received geographic location information to check for inappropriate data structures.

18. The method of claim 10, further comprising, validating the received geographic location information to check for file formatting errors.

19. The method of claim 10 wherein the geographic location coordinate information includes global positioning system (GPS) coordinate information.

20. The method of claim 10 wherein the geographic location coordinate information includes coordinates other than global positioning system (GPS) coordinates.

21. The method of claim 10, further comprising receiving a user command to edit the geographic location information, wherein the editing includes modifying the geographic location information related to at least one of the data collection points.

22. The method of claim 10, further comprising receiving a user command to update the data structure, wherein the updating includes adding information related to new data collection points to the data structure.

23. The method of claim 10, further comprising exporting the data structure to a customer information system.

24. A system for locating data collection points in a mobile utility data collection system, the method comprising:
means for receiving geographic location information for multiple intermediate data points used in providing information to the mobile utility data collection system, wherein the geographic location information for the multiple intermediate data points includes complete or incomplete address information and complete or incomplete geographic location coordinate information for locating the intermediate data points;
means for validating the received geographic location information;
means for determining complete geographic location coordinate information for the at least one data collection points if the geographic location coordinate information for at least one data collection points is incomplete; and
means for providing access to the geographic location information, wherein the access allows for modification of the geographic location information by a user.

25. The system of claim 24 wherein the mobile data collection system collects information related to utility consumption.

26. The system of claim 24 wherein the mobile data collection system collects information related to utility meters.

27. A method for managing utility endpoint location files that include geographic information used for locating utility data collection points in a mobile utility data collection system, the method comprising:
providing an editing component in association with the mobile utility data collection system, wherein the editing component includes functions for managing the utility endpoint location files that include geographic location information used for locating utility data collection points in the mobile utility data collection system; and
wherein the geographic location information for the multiple utility data collection points includes complete or incomplete address information and complete or incomplete geographic location coordinate information.

28. The method of claim 27 wherein the various functions of the editing component include an import function configured for importing one or more utility endpoint location files from a utility system or meter reading application.

29. The method of claim 27 wherein the various functions of the editing component include an import and calculate function configured for importing one or more utility endpoint location files from a utility system or meter reading application and, if the geographic location coordinate information for at least one utility data collection point of the imported one or more utility endpoint location files is incomplete, determining complete geographic location coordinate information for the at least one data collection point.

30. The method of claim 27 wherein the various functions of the editing component include an export function configured for exporting one or more utility endpoint location files from the mobile utility data collection system to a utility system or meter reading application.

31. The method of claim 27 wherein the various functions of the editing component include an export filtered function configured for exporting filtered information associated with one or more utility endpoint location files from the mobile utility data collection system to a utility system or meter reading application.

32. The method of claim 27 wherein the various functions of the editing component include an apply function configured for applying changes made to a currently selected utility endpoint location file.

33. The method of claim 27 wherein the various functions of the editing component include a cancel function configured for canceling changes made to a currently selected utility endpoint location file.

34. The method of claim 27 wherein the various functions of the editing component include a current location function configured for allowing a user to insert location information for a utility data collection point associated with a utility endpoint location file, wherein the inserting of location information is performed by collecting GPS coordinate information while the mobile utility data collection system is located physically at or near the physical location/address of the at least one utility data collection point.

35. The method of claim 27 wherein the various functions of the editing component include a calculate selected function configured for determining complete geographic location coordinate information for a currently selected utility endpoint location file.

36. The method of claim 27 wherein the various functions of the editing component include a calculate all function configured for determining complete geographic location information for any incomplete geographic location coordinate information associated with a currently selected utility endpoint location file.

37. The method of claim 27 wherein the various functions of the editing component include a filter function configured for receiving filter criteria and for selecting records from one or more utility endpoint location files based on the received filter criteria.
